(19) United States
(12) Patent Application Publication
(10) Pub. No.: US 2017/0371694 A1
(43) Pub. Date: Dec. 28, 2017

(54) VIRTUALIZATION OF A GRAPHICS PROCESSING UNIT FOR NETWORK APPLICATIONS

(71) Applicant: Advanced Micro Devices, Inc., Sunnyvale, CA (US)

(72) Inventor: Seong Hwan Kim, San Jose, CA (US)

(21) Appl. No.: 15/190,735

(22) Filed: Jun. 23, 2016

(51) Int. Cl. G06F 9/455; G06T 1/20

(52) U.S. Cl. CPC G06F 9/45558; G06T 1/20; G06F 2009/45583; G06F 2009/45595; G06T 2200/28

(57) ABSTRACT

An accelerated processing unit includes a first processing unit configured to implement one or more virtual machines and a second processing unit configured to implement one or more acceleration modules. The one or more virtual machines are configured to provide information identifying a task or data to the one or more acceleration modules via first queues. The one or more acceleration modules are configured to provide information identifying results of an operation performed on the task or data to the one or more virtual machines via one or more second queues.

### BACKGROUND

### Description of the Related Art

A computing device can include a central processing unit (CPU) and a graphics processing unit (GPU). The CPU and the GPU may include multiple processor cores that can execute tasks concurrently or in parallel. The CPU can interact with external devices via a network interface controller (NIC) that is used to transmit signals onto a line that is connected to a network and receive signals from the line. Processor cores in the CPU may be used to implement one or more virtual machines that each function as an independent processor capable of executing one or more applications. For example, an instance of a virtual machine running on the CPU may be used to implement an email application for sending and receiving emails via the NIC. The virtual machines implement separate instances of an operating system, as well as drivers that can support interaction with the NIC. The CPU is connected to the NIC by an interface such as a peripheral component interconnect (PCI) bus. However, a conventional computing device does not provide support for network acceleration for virtual machines that can utilize network acceleration modules implemented by the GPU.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system according to some implementations.

FIG. 2 is a block diagram of a processing system that includes virtual machine queues for conveying packets including information identifying tasks or data between virtual machines and acceleration functions according to some implementations.

FIG. 3 is a block diagram of a processing system that includes task queues for conveying packets including information identifying tasks or data between virtual machines and acceleration functions according to some implementations.

FIG. 4 is a block diagram that illustrates mapping of virtual memory to a shared memory in a processing system according to some implementations.

FIG. 5 is a block diagram of a processing system that implements a look aside operational model for an acceleration engine according to some implementations.

FIG. 6 is a block diagram of a processing system that implements an inline operational model for an acceleration engine according to some implementations.

FIG. 7 is a block diagram of a processing system that includes virtual machine queues and task queues for conveying packets including information identifying tasks or data between virtual machines and acceleration functions according to some implementations.

FIG. 8 is a flow diagram illustrating a method of processing packets received from a network according to some implementations.

### DETAILED DESCRIPTION

Network applications running on a CPU can be improved by implementing virtual network acceleration modules on a GPU. In some implementations, the GPU is integrated or embedded with the CPU, to form an APU. These are the implementations used in illustrative examples in the rest of this document. Alternatively, in other implementations, one or more external GPUs coupled to a CPU or an APU through a shared memory architecture can serve as a network accelerator as discussed herein. The virtual network acceleration modules can include a classification module, a deep packet inspection (DPI) module, an encryption module, a compression module, and the like. Some implementations of the APU include a CPU that includes one or more processor cores for implementing one or more virtual machines and a GPU that includes one or more compute units that can be used to implement one or more network acceleration modules. The virtual machines and the network acceleration modules exchange information identifying tasks or data using a shared memory, e.g., a shared memory implemented as part of a Heterogeneous System Architecture (HSA). In some variations, the identifying information includes a task, data, or a pointer to a shared memory location that stores the task or data. For example, the shared memory can implement a set of queues to receive information identifying tasks or data from the virtual machine and provide the information to the appropriate network acceleration module. The set of queues also receives information from the network acceleration modules and provides it to the appropriate virtual machine. In some variations, each of the queues is used to convey information for corresponding virtual machines or corresponding network acceleration modules. The virtual machines share the network acceleration modules, which can perform operations on tasks or data provided by any of the virtual machines supported by the CPU or the NIC. For example, the NIC can receive email packets from the network and provide the email packets to a classification module implemented by the GPU. The classification module determines a destination virtual machine for the email packets and sends the email packets to a queue accessible by the destination virtual machine. For another example, the virtual machine sends the email packets to a queue accessible by the DPI module, which uses the information to access and inspect the email packets. The DPI module returns inspection results (such as information indicating an alarm due to a potential virus in the email packet/packets) to the virtual machine via a queue accessible by the virtual machine.

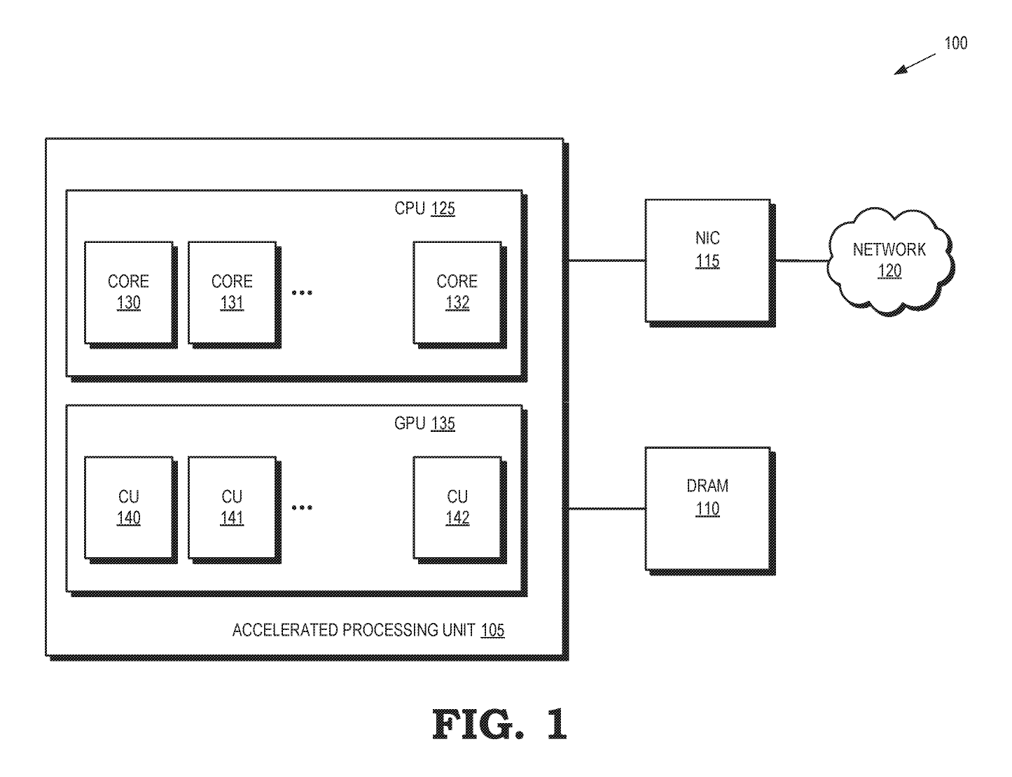

FIG. 1 is a block diagram of a processing system 100 according to some implementations. The processing system includes an accelerated processing unit 105 that is connected to a memory such as a dynamic random access memory (DRAM) 110. The accelerated processing unit 105 is also connected to a network interface card (NIC) 115 that provides an interface between the accelerated processing unit 105 and a network 120. Some implementations of the NIC 115 are configured to support communication at the physical layer and the data link layer. Although the NIC 115 is depicted as external to the accelerated processing unit 105, some implementations of the NIC 115 are implemented on the same chip or board as the accelerated processing unit 105.

One or more central processing units (CPUs) 125 are implemented on the accelerated processing unit 105. The CPU 125 includes processor cores 130, 131, 132, which are collectively referred to herein as “the processor cores 130-132.” Some implementations of the processor cores 130-132 execute tasks concurrently or in parallel. Some implementations of the processor cores 130-132 implement one or more virtual machines that use software to emulate a computer system that executes tasks like a physical machine. A system-level virtual machine can provide a complete system platform that supports execution of an operating system for running applications such as a server application, an email application, web server, security applications, and the like. Virtual machines are not necessarily constrained to be executed on a particular one of the processor cores 130-132 or on any particular combination of the processor cores 130-132. Moreover, the number of virtual machines implemented by the CPU 125 is not necessarily constrained by the number of processor cores 130-132. The processor cores 130-132 can therefore implement more or fewer virtual machines than existing processor cores.

One or more graphics processing units (GPUs) 135 are also implemented on the accelerated processing unit 105. The GPU 135 includes compute units 140, 141, 142, which are collectively referred to herein as “the compute units 140-142.” Some implementations of the compute units 140-142 implement acceleration functions that are used to improve the performance of the accelerated processing unit 105 by processing tasks or data for the virtual machines implemented in the CPU 125. The acceleration functions include network acceleration functions such as a classification module for classifying the tasks or data, an encryption module to perform encryption or decryption of the tasks or data, a deep packet inspection (DPI) module to inspect tasks or data for viruses or other anomalies, and a compression module for compressing or decompressing the tasks or data. The acceleration functions are not necessarily implemented by any particular one of the compute units 140-142 or any combination of the compute units 140-142. In some variations, one or more of the compute units 140-142 implement the acceleration functions in a virtualized manner. Each of the acceleration functions is exposed to the virtual machines implemented by the CPU 125. The virtual machines can therefore share each of the acceleration functions, as discussed herein.

Queues are implemented in the DRAM 110 and used to convey information identifying the tasks or data between the virtual machines implemented in the CPU 125 and the acceleration functions implemented in the GPU 135. In some variations, pairs of queues are implemented in the DRAM 110. One queue in each pair includes entries for storing information identifying tasks or data that are received from the virtual machines in the CPU 125 and are provided to the acceleration functions implemented by the GPU 135. The other queue in each pair includes entries for storing information identifying the results of operations performed by the acceleration functions based on the received tasks or data. The information identifying the results is received from the acceleration functions in the GPU 135 and provided to the virtual machines in the CPU 125. In some implementations, each pair of queues is associated with a virtual machine so that each virtual machine provides information to and receives information only via a dedicated pair of virtual machine queues, which can distribute the information to the appropriate acceleration function in the GPU 135. In some implementations, each pair of queues is associated with an acceleration function so that the information identifying tasks or data is provided to or received from the corresponding acceleration function only via a dedicated pair of task queues. The information identifying the tasks or data can be a pointer to a location in the DRAM 110 (or other memory) that stores the task or data so that the actual task or data does not need to be exchanged via the queues.

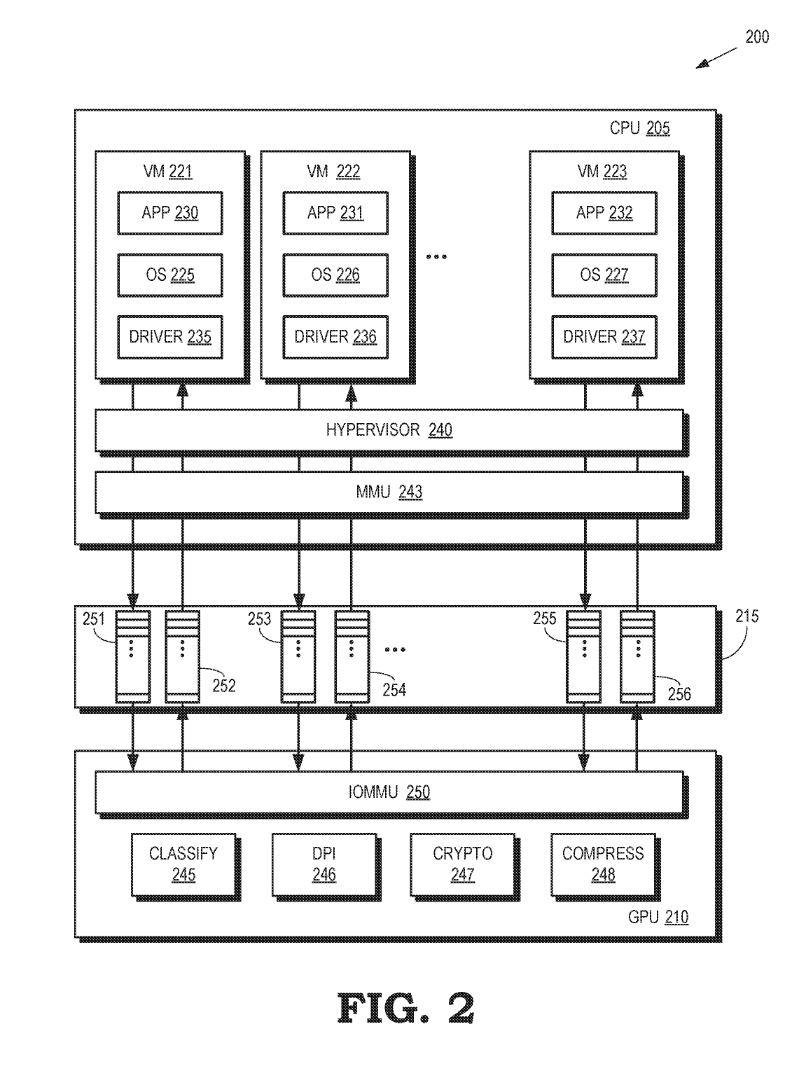

FIG. 2 is a block diagram of a processing system 200 that includes virtual machine queues for conveying packets including information identifying tasks or data between virtual machines and acceleration functions according to some implementations. The processing system 200 is used in some implementations of the processing system 100 shown in FIG. 1. The processing system 200 includes a CPU 205 that is interconnected with a GPU 210 using a shared memory 215. Some implementations of the shared memory 215 are implemented using a DRAM such as the DRAM 110 shown in FIG. 1.

The CPU 205 implements virtual machines 220, 221, 222 (collectively referred to herein as “the virtual machines 221-223”) using one or more processor cores such as the processor cores 130-132 shown in FIG. 1. The virtual machines 221-223 implement different instances of an operating system 225, 226, 227 (collectively referred to herein as “the operating systems 225-227”), which are guest operating systems 225-227 in some implementations. The virtual machines 221-223 support one or more independent applications 230, 231, 232 (collectively referred to herein as “the applications 230-232”) such as server applications, cloud computing applications, file storage applications, email applications, and the like. The virtual machines 221-223 also implement one or more drivers 235, 236, 237 (collectively referred to herein as “the drivers 235-237”) that provide a software interface between the applications 230-232 and hardware devices in the processing system 200. For example, the drivers 235-237 can include network interface controller (NIC) drivers for providing a software interface between the applications 230-232 and an NIC such as the NIC 115 shown in FIG. 1.

A hypervisor 240 is used to create and run the virtual machines 221-223. For example, the hypervisor 240 may instantiate a virtual machine 221-223 in response to an event such as a request to implement one of the applications 230-232 supported by the CPU 205. Some implementations of the hypervisor 240 provide a virtual operating platform for the operating systems 225-227. The CPU 205 also includes a memory management unit 243 that is used to support access to the shared memory 215. For example, the memory management unit 243 can perform address translation between the virtual addresses used by the virtual machines 221-223 and physical addresses in the shared memory 215.

The GPU 210 implements acceleration functions using modules that can receive, process, and transmit packets including information such as information identifying tasks or data. The acceleration modules include a classify module 245 for classifying packets based on the information included in the packets, a deep packet inspection (DPI) module 246 to inspect the packets for viruses or other anomalies, a crypto module 247 to perform encryption or decryption of the information included in the packets, and a compress module 248 for compressing or decompressing the packets. The modules 245-248 are implemented using one or more compute units such as the compute units 141-143 shown in FIG. 1. The modules 245-248 are implemented using any number of compute units, e.g., the modules 245-248 can be virtualized. The modules 245-248 are not tied to any particular virtual machine 221-223 and so their functionality can be shared by the virtual machines 221-223. For example, the applications 230-232 all have the option of sending packets to the classify module 245 for classification, to the DPI module 246 for virus inspection, to the crypto module 247 for encryption or decryption, or to the compress module 248 for compression or decompression. To support application acceleration, a GPU acceleration driver are implemented in some variations of the virtual machines 221-223 that are configured to use GPU acceleration. For example, the GPU acceleration drivers can be implemented as part of the drivers 235 237.

The GPU 210 also includes an input/output memory management unit (IOMMU) 250 that is used to connect devices (such as the NIC 115 shown in FIG. 1) to the shared memory 215. For example, the I/O memory management unit 250 can perform address translation between the device virtual addresses used by devices such as NICs and physical addresses in the shared memory 215. The I/O memory management unit 250 may also be used to route packets based on information such as virtual addresses included in packets.

The shared memory 215 supports queues 251, 252, 253, 254, 255, 256, which are collectively referred to herein as “the queues 251-256.” Entries in the queues 251-256 are used to store packets including information identifying tasks or data, such as a pointer to a location in the memory 215 (or other memory) that includes the task or data. Pairs of the queues 251-256 are associated with corresponding virtual machines 221-223 and the queues 251-256 are sometimes referred to herein as virtual machine queues 251-256. For example, the queues 251, 252 are associated with the virtual machine 221, the queues 253, 254 are associated with the virtual machine 222, and the queues 255, 256 are associated with the virtual machine 223. One of the queues in each pair is used to convey packets from the corresponding virtual machine to the GPU 210 and the other one of the queues in each pair is used to convey information from the GPU 210 to the corresponding virtual machine. For example, the queue 251 receives packets including information identifying the task or data only from the virtual machine 221 and provides the packets to the GPU 210. The queue 252 receives packets from the GPU 210 that is destined for only the virtual machine 221. The virtual machines 222, 223 do not provide any packets to the queue 251 and do not receive any packets from the queue 252.

The I/O memory management 250 in the GPU 210 routes packets between the queues 251-256 and the modules 245-248. In some implementations, the packet including information identifying the tasks or data also includes information identifying one of the virtual machines 221-223 or one of the modules 245-248. This information is used to route the packet. For example, the I/O memory management 250 can receive a packet from the queue 251 that includes a pointer to a location that stores data and information identifying the DPI module 246. The I/O memory management 250 routes the packet to the DPI module 246, which uses the pointer to access data and perform deep packet inspection. Results of the deep packet inspection (such as an alarm if a virus is detected) are transmitted from the DPI module 246 in a packet that includes the results and information identifying the virtual machine 221. The I/O memory management unit 250 routes the packet to the queue 252 based on the information identifying the virtual machine 221. In some implementations, packets including the information identifying the virtual machines 221-223 or the modules 245-248 are provided by the drivers 235-237, which can attach this information to packets that are transmitted to the queues 251-256.

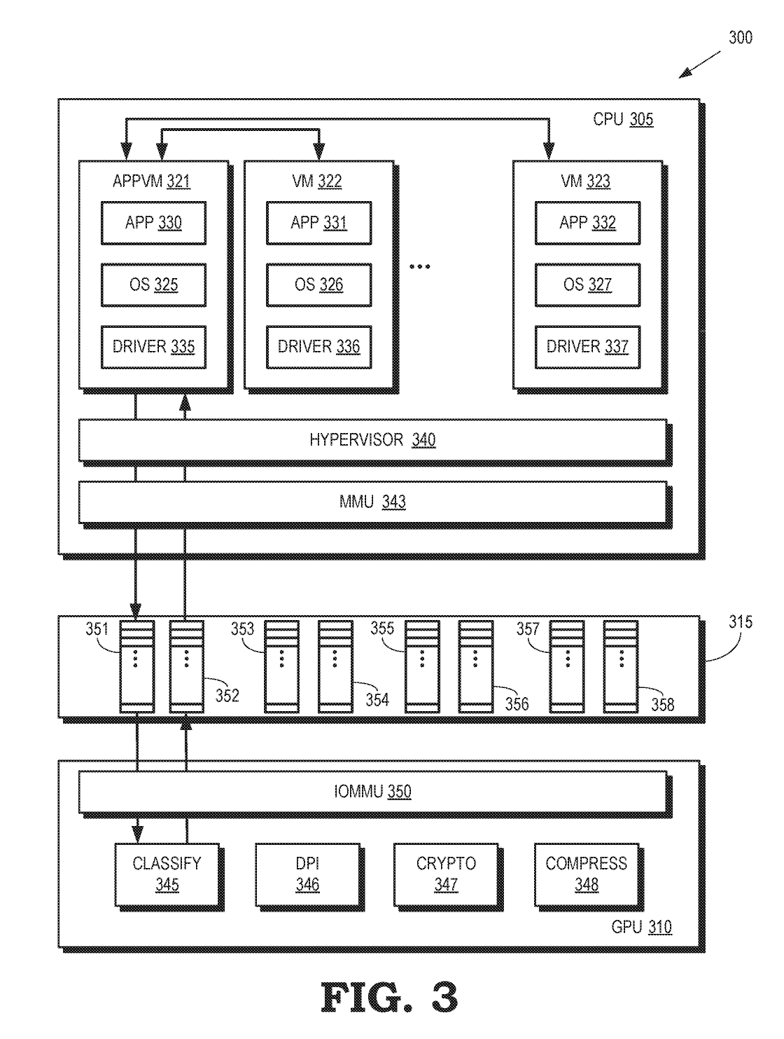

FIG. 3 is a block diagram of a processing system 300 that includes task queues for conveying packets including information identifying tasks or data between virtual machines and acceleration functions according to some implementations. The processing system 300 is used in some implementations of the processing system 100 shown in FIG. 1. The processing system 300 includes a CPU 305 that is interconnected with a GPU 310 using a shared memory 315, which can be implemented using a DRAM such as the DRAM 110 shown in FIG. 1.

The CPU 305 implements an application virtual machine 320 and virtual machines 321, 322 (collectively referred to herein as “the virtual machines 321-323”) using one or more processor cores such as the processor cores 130-132 shown in FIG. 1. The virtual machines 321-323 implement different instances of an operating system 325, 326, 327 (collectively referred to herein as “the operating systems 325-327”), which are guest operating systems 325-327 in some implementations. The virtual machines 321-323 support one or more independent applications 330, 331, 332 (collectively referred to herein as “the applications 330-332”) such as server applications, cloud computing applications, file storage applications, email applications, and the like. The virtual machines 321-323 also implement one or more drivers 335, 336, 337 (collectively referred to herein as “the drivers 335-337”) that provide a software interface between the applications 330-332 and hardware devices in the processing system 300. For example, the drivers 335-337 can include network interface card (NIC) drivers for providing a software interface between the applications 330-332 and a NIC such as the NIC 115 shown in FIG. 1.

The application virtual machine 321 differs from the virtual machines 322, 323 because the application virtual machine 321 is configured to mediate communication between the virtual machines 321-323 and an acceleration function in the GPU 310. For example, as discussed in more detail below, the application virtual machine 321 mediates communication of tasks or data between the virtual machines 322, 323 and a classify module 345. Although only a single application virtual machine 321 is shown in FIG. 3 in the interest of clarity, additional application virtual machines can be instantiated in the CPU 305 to mediate communication with other acceleration functions implemented in the GPU 310. The virtual machines 322, 323 do not communicate directly with the GPU 310. Instead, the virtual machines 322, 323 transmit packets of information such as tasks or data associated with the classify module 345 to the application virtual machine 321, as indicated by the double-headed arrows. The application virtual machine 321 processes and forwards the packets to the classify module 345 in the GPU 310 via the shared memory 315. In some variations, the application virtual machine 321 also receives information from the GPU 310 and forwards this information to the appropriate virtual machine 322, 323.

A hypervisor 340 is used to create and run the virtual machines 321-323. For example, the hypervisor 340 is able to instantiate a virtual machine 321-323 in response to an event such as a request to implement one of the applications 330-332 supported by the CPU 305. For another example, the hypervisor 340 is able to instantiate an application virtual machine 321 in response to the GPU 310 configuring a corresponding acceleration function. Some implementations of the hypervisor 340 provide a virtual operating platform for the operating systems 325-327. The CPU 305 also includes a memory management unit 343 that is used to support access to the shared memory 315. For example, the memory management unit 343 can perform address translation between the virtual addresses used by the virtual machines 321-323 and physical addresses in the shared memory 315.

The GPU 310 implements acceleration functions using modules including a classify module 345 for classifying packets including information indicating tasks or data, a DPI module 346 to inspect the packets for viruses or other anomalies, a crypto module 347 to perform encryption or decryption of information included in the packets, and a compress module 348 for compressing or decompressing information included in the packets. The modules 345-348 are implemented using one or more compute units such as the compute units 141-143 shown in FIG. 1. The modules 345-348 can be implemented using any number of compute units, e.g., the modules 345-348 are virtualized in some implementations. Each of the modules 345-348 is associated with an application virtual machine implemented in the CPU 305. For example, the classify module 345 is associated with the application virtual machine 321 so that all packets of information exchanged between the classify module 345 and the virtual machines 321-323 passes through the application virtual machine 321. Although not shown in FIG. 3 in the interest of clarity, the CPU 305 supports additional application virtual machines associated with the DPI module 346, the crypto module 347, and the compress module 348.

Functionality of the modules 345-348 can be shared by the virtual machines 321-323. For example, the applications 330-332 are all able to send packets of data to the classify module 345 for classification, to the DPI module 346 for virus inspection, to the crypto module 347 for encryption or decryption, or to the compress module 348 for compression or decompression. However, as discussed herein, the packets of data are conveyed to the classify module 345 via the application virtual machine 321 and the packets of data are conveyed to the other modules 346-348 via other application virtual machines hosted by the CPU 305.

The GPU 310 also includes an input/output memory management unit (IOMMU) 350 that is used to connect devices (such as the NIC 115 shown in FIG. 1) to the shared memory 315. For example, the I/O memory management unit 350 can perform address translation between the device virtual addresses used by devices such as NICs and physical addresses in the shared memory 315. The I/O memory management unit 350 may route packets based on information such as virtual addresses included in the packets.

The shared memory 315 supports queues 351, 352, 353, 354, 355, 356, 357, 358, which are collectively referred to herein as “the queues 351-358.” Entries in the queues 351-358 are used to store packets including information identifying tasks or data, such as a pointer to a location in the memory 315 (or other memory) that includes the task or data. Pairs of the queues 351-358 are associated with corresponding acceleration modules 345-348 and the queues 351-358 are sometimes referred to herein as task queues 351-358. For example, the queues 351, 352 are associated with the classify module 345, the queues 353, 354 are associated with the DPI module 346, the queues 355, 356 are associated with the crypto module 347, and the queues 357, 358 are associated with the compress module 348. Each pair of queues 351-358 is also associated with a corresponding application virtual machine. For example, the queues 351, 352 are associated with the application virtual machine 321. One of the queues in each pair is used to convey packets from the corresponding application virtual machine to the associated acceleration function in the GPU 310 and the other one of the queues in each pair is used to convey packets from the associated acceleration function in the GPU 310 to the corresponding application virtual machine. For example, the queue 351 receives a packet including information identifying the task or data only from the application virtual machine 321 and provides the packet only to the classify module 345. The queue 352 receives packets only from the classify module 345 and provides the packets only to the application virtual machine 321.

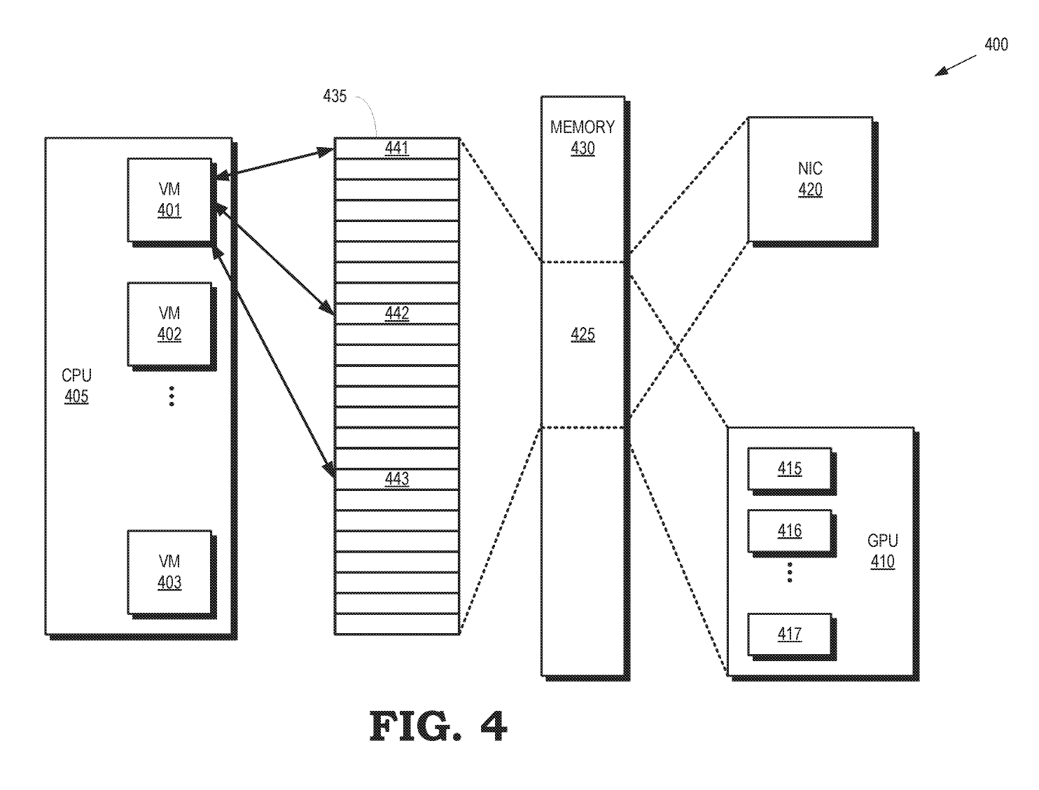

FIG. 4 is a block diagram that illustrates mapping of virtual memory to a shared memory in a processing system 400 according to some implementations. The processing system 400 is used in some implementations of the processing system 100 shown in FIG. 1. The processing system 400 includes virtual machines 401, 402, 403 (collectively referred to herein as “the virtual machines 401-403”) that are implemented on one or more processor cores of a CPU 405 that is used in some implementations of the accelerated processing unit 105 shown in FIG. 1. The processing system also includes a GPU 410 that implements acceleration modules 415, 416, 417 (collectively referred to herein as “the acceleration modules 415-417”) that are implemented using one or more compute units such as the compute units 141-143 shown in FIG. 1. The processing system 400 also includes an NIC 420, which is used in some implementations of the NIC 115 shown in FIG. 1.

The CPU 405, the GPU 410, and the NIC 420 are configured to access a shared portion 425 of a memory 430. In some implementations, the CPU 405, the GPU 410, and the NIC 420 use virtual addresses to indicate locations in the shared portion 425 of the memory 430. The virtual addresses are translated into physical addresses of the locations in the shared portion 425. For example, the CPU 405 uses a virtual address range 435 to indicate locations in the shared portion 425. In some variations, the virtual machines 401-403 are assigned or allocated virtual memory addresses, sets of addresses, or address ranges to indicate locations of tasks or data. For example, the virtual machine 401 can be assigned the virtual addresses 441, 442, 443 and use these virtual addresses to perform operations such as stores to the locations, loads from the locations, arithmetical operations on data stored at these locations, transcendental operations on data stored at these locations, and the like. The virtual addresses 441-443 are mapped to corresponding physical addresses in the shared portion 425, e.g., by a memory management unit such as the memory management unit 243 shown in FIG. 2 or the memory management unit 343 shown in FIG. 3. Although not shown in FIG. 4 in the interest of clarity, the GPU 410 and the NIC 420 are able to use corresponding virtual address ranges to indicate locations in the shared portion 425.

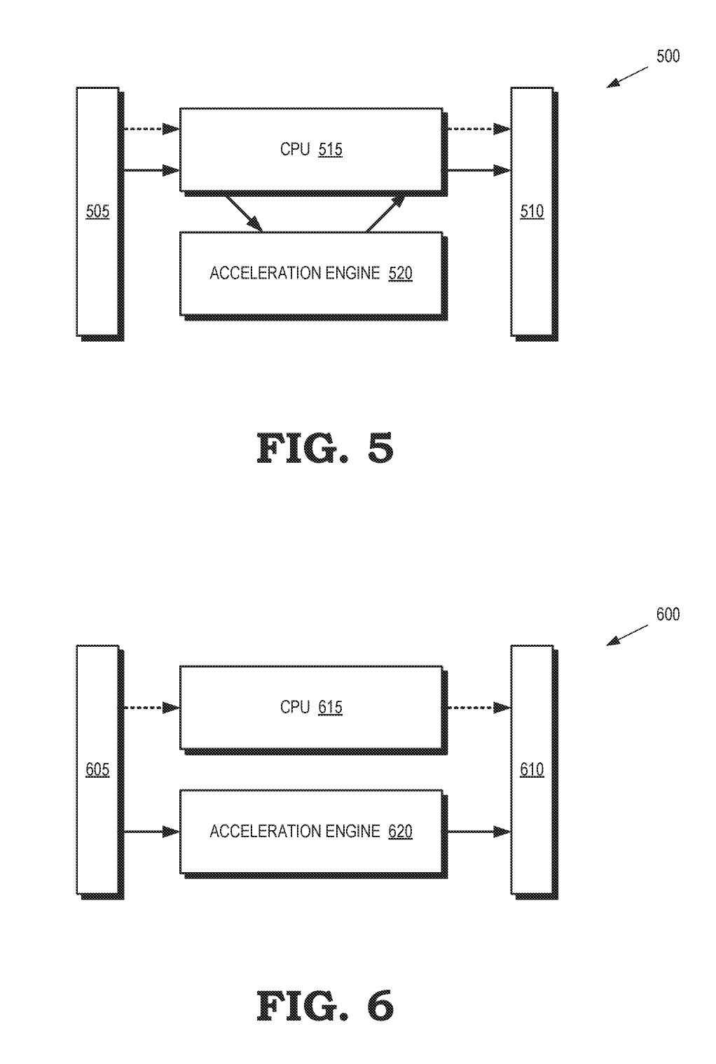

FIG. 5 is a block diagram of a processing system 500 that implements a look aside operational model for an acceleration engine according to some implementations. The processing system 500 is used in some implementations of the processing system 100 shown in FIG. 1. Packets of information (such as information identifying tasks or data) are received at an input interface 505 and are transmitted at an output interface 510. Some implementations of the input interface 505 or the output interface 510 are implemented in an NIC such as the NIC 115 shown in FIG. 1. Control information received at the input interface 505 is provided to a CPU 515, which can process the control information and forward modified control information or additional control information to the output interface 510, as indicated by the dotted arrows.

The CPU 515 also receives the packets of information, as indicated by the solid arrow. The CPU 515 is able to forward the packets of information to an acceleration engine 520 (as indicated by the solid arrow) that implements one or more acceleration functions. Some implementations of the acceleration engine 520 are used by a GPU such as the GPU 135 shown in FIG. 1. The acceleration engine 520 performs one or more operations using the tasks or data included in the packet and then returns one or more packets including information indicating the results of the operations to the CPU 515, which provides the packets including the results (or other information produced based on the results) to the output interface 510.

FIG. 6 is a block diagram of a processing system 600 that implements an inline operational model for an acceleration engine according to some implementations. The processing system 600 is used in some implementations of the processing system 100 shown in FIG. 1. Packets of information (such as information identifying tasks or data) are received at an input interface 605 and are transmitted at an output interface 610. Some implementations of the input interface 605 or the output interface 610 are implemented in an NIC such as the NIC 115 shown in FIG. 1. Control information received at the input interface 605 is provided to a CPU 615, which is able to process the control information and forward modified control information or additional control information to the output interface 610, as indicated by the dotted arrows.

The processing system 600 differs from the processing system 500 shown in FIG. 5 because an acceleration engine 620 receives packets including information (such as tasks or data) directly from the input interface 610, as indicated by the solid arrows, instead of receiving these packets from the CPU 615. The packet flow therefore bypasses the CPU 615 and acceleration functions implemented by the acceleration engine 620 can perform operations based on the tasks or data included in the packets without additional input from the CPU 615. For example, a classify module implemented in the acceleration engine 620 can classify an incoming packet as a packet that requires one or more of DPI, encryption/decryption, or compression/decompression. The classify module then directs the incoming packet to the appropriate module (or modules), which can perform the indicated operations. Once the operations are complete, the modified packet information or other results of the operations are provided to the output interface 610 for transmission to an external network.

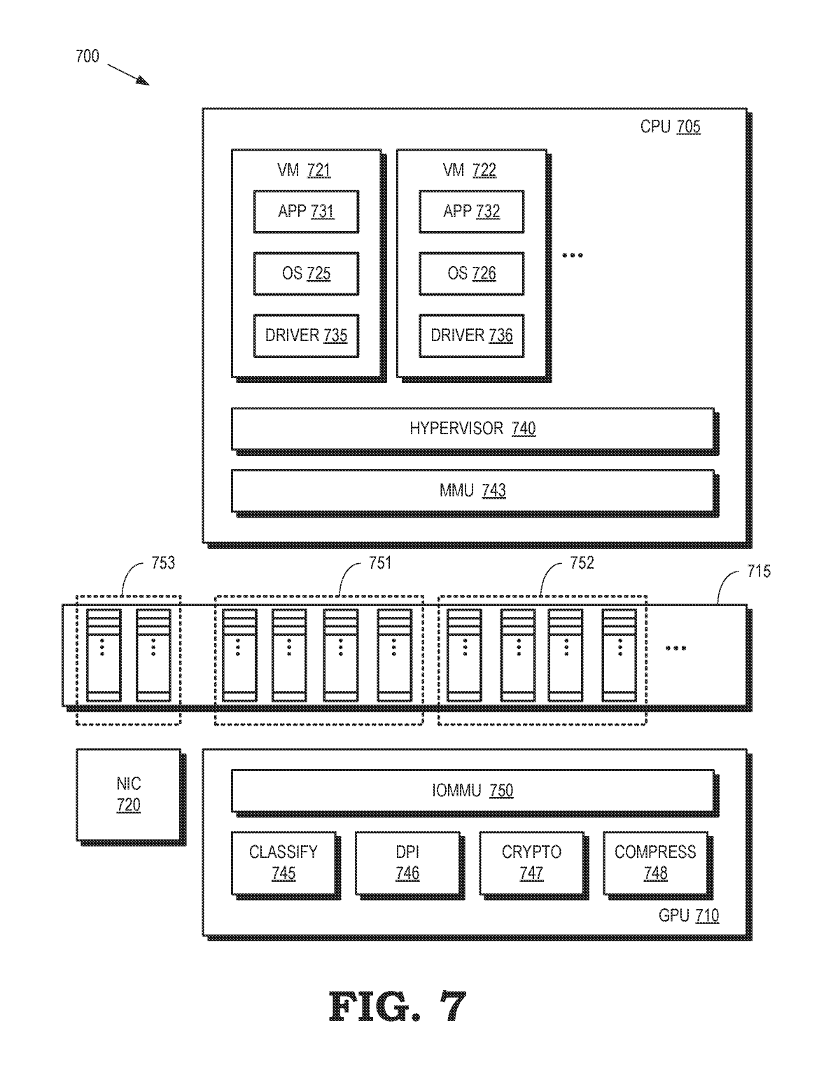

FIG. 7 is a block diagram of a processing system 700 that includes virtual machine queues and task queues for conveying packets including information identifying tasks or data between virtual machines and acceleration functions according to some implementations. The processing system 700 is used in some implementations of the processing system 100 shown in FIG. 1. The processing system 700 includes a CPU 705 that is interconnected with a GPU 710 using a shared memory 715, which can be implemented using a DRAM such as the DRAM 110 shown in FIG. 1. The GPU 710 is also interconnected with an NIC 720 via the shared memory 715.

The CPU 705 implements virtual machines 721, 722 using one or more processor cores such as the processor cores 130-132 shown in FIG. 1. Some implementations of the virtual machines 721, 722 include application virtual machines for mediating communication between other virtual machines and queues associated with modules in the GPU 710, as discussed herein. The virtual machines 721, 722 implement different instances of an operating system 725, 726, which are guest operating systems 725, 726 in some implementations. The virtual machines 721, 722 may therefore support one or more independent applications 731, 732 such as server applications, cloud computing applications, file storage applications, email applications, and the like. The virtual machines 721, 722 also implement one or more drivers 735, 736 that provide a software interface between the applications 731, 732 and hardware devices such as the NIC 720. The CPU 705 also implements a hypervisor 740 and a memory management unit 743.

The GPU 710 implements acceleration functions using modules including a classify module 745 for classifying packets including information indicating tasks or data, a DPI module 746 to inspect the packets for viruses or other anomalies, a crypto module 747 to perform encryption or decryption of information included in the packets, and a compress module 748 for compressing or decompressing information included in the packets. The modules 745-748 are implemented using one or more compute units such as the compute units 141-143 shown in FIG. 1. The modules 745-748 can be implemented using any number of compute units, e.g., the modules 745-748 are virtualized in some implementations. Each of the modules 745-748 is associated with an application virtual machine implemented in the CPU 705. Functionality of the modules 745-748 can be shared by the virtual machines 721, 722. The GPU 710 also includes an input/output memory management unit (IOMMU) 750.

The shared memory 715 supports sets of four virtual machine queues 751, 752 for the virtual machines 721, 722. For example, the set 751 includes one queue for receiving data at the virtual machine 721, one queue for transmitting data from the virtual machine 721, one queue for receiving tasks at the virtual machine 721, and one queue for transmitting tasks from the virtual machine 721. The shared memory 715 also supports interface queues 753 that are associated with the NIC 720. The pair of interface queues 753 is used to convey packets between the NIC 720 and the classify module 745. Entries in the queues 751-753 are used to store packets including information identifying tasks or data, such as a pointer to a location in the memory 715 (or other memory) that includes the task or data.

In operation, the classify module 745 receives packets from one of the interface queues 753, such as a packet including data destined for one of the virtual machines 721, 722. The classify module 745 reads packet header information included in the packet and identifies one or more of the virtual machines 721, 722 as a destination for the packet. The classify module 745 adds a virtual machine identifier indicating the destination of the packet and forwards the packet to one of the virtual machine queues in 715 that is associated with the destination virtual machine. For example, if the destination virtual machine is the virtual machine 721, the packet of data is forwarded to the data receive queue in the set 751 associated with the virtual machine 721. The virtual machines 721, 722 can poll the virtual machine queues in 715 to detect the presence of packets and, if a packet is detected, the virtual machines 721, 722 retrieve the packet from the queue for processing. The virtual machines 721, 722 are also able to use the virtual machine identifier to confirm the destination of the packet. In some variations, the virtual machines 721, 722 provide packets to the virtual machine queues in 715 for transmission to an external network via the NIC 720.

Packets are conveyed between the virtual machines 721, 722 and the acceleration modules 745-748 via the task queues 752. For example, the virtual machine 721 can send a packet to one of the task queues 752 associated with the DPI module 746 so that the DPI module 746 can perform the packet inspection to detect viruses or other anomalies in the packet. The DPI module 746 polls the appropriate task queue 752 to detect the presence of the packet and, if the packet is detected, the DPI module 746 retrieves the packet and performs deep packet inspection. A packet indicating results of the inspection is placed in one of the task queues 752 and the virtual machine 721 can retrieve the packet from the task queue 752. In some implementations, different task queues 752 are assigned different levels of priority for processing by the modules 745-748.

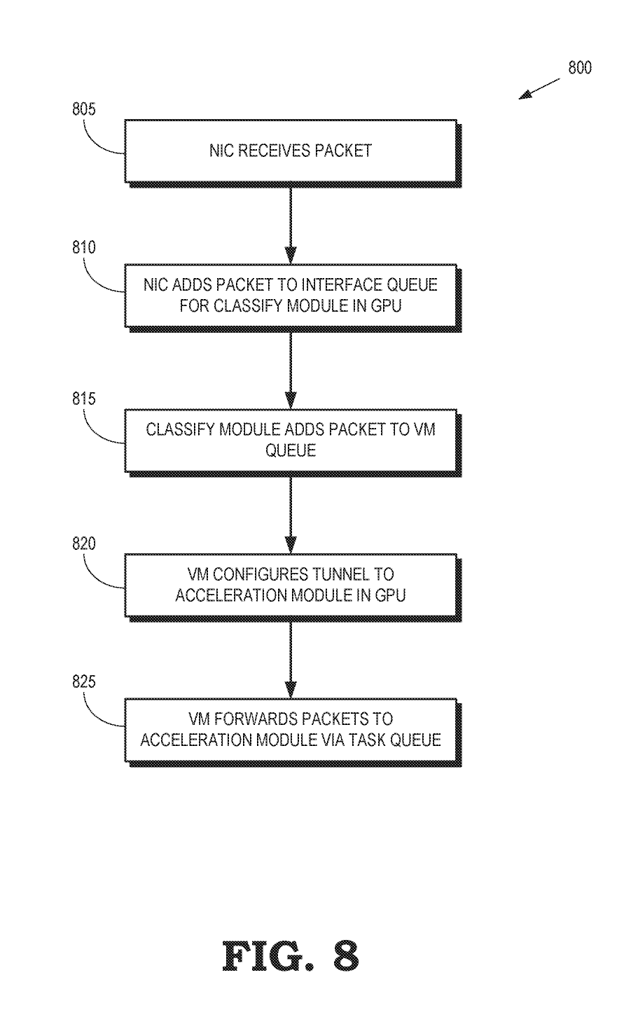

FIG. 8 is a flow diagram illustrating a method 800 of processing packets received from a network according to some implementations. The method 800 is used by some implementations of the processing system 100 shown in FIG. 1. At block 805, an NIC such as the NIC 115 shown in FIG. 1 or the NIC 720 shown in FIG. 7 receives a packet from an external network. At block 810, the NIC adds the packet to an interface queue (such as the interface queues 753 shown in FIG. 7) to store the packet for subsequent use by a classification module in the GPU such as the GPU 135 shown in FIG. 1, the GPU 210 shown in FIG. 2, the GPU 310 shown in FIG. 3, or the GPU 710 shown in FIG. 7. At block 815, the classify module retrieves the packet from the interface queue, determines a destination virtual machine based on information in the packet header, and adds the packet to a virtual machine queue corresponding to the destination virtual machine.

At block 820, the virtual machine retrieves the packet from its corresponding virtual machine queue, determines whether to perform additional processing on the packet using an acceleration module, and then configures a tunnel to the appropriate acceleration module in the GPU. Configuring the tunnel can include selecting an appropriate task queue and, if necessary, establishing communication between the virtual machine and an application virtual machine that mediates the flow of packets between virtual machines and its corresponding task queue. At block 825, the virtual machine forwards the packet to the acceleration module via the selected task queue and, if present, the corresponding application virtual machine. After processing, the acceleration module provides a packet including results of the operation to the virtual machine (via the corresponding task queue) or to the NIC (via an interface queue) for transmission to the external network. In some variations, the virtual machines transmit packets to the NIC via the interface queues for transmission to the external network.

In some implementations, certain aspects of the techniques described above are implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium can be in source code, assembly language code, object code, or other instruction format that is interpreted or otherwise executable by one or more processors.

A computer readable storage medium can include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium can be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a first processing unit configured to implement at least one virtual machine; and
a second processing unit configured to implement at least one acceleration module, wherein the at least one virtual machine is configured to provide a first packet including information identifying at least one of a task and data to the at least one acceleration module via a first queue, and wherein the at least one acceleration module is configured to provide a second packet including information identifying results of an operation performed on at least one of the task and the data to the at least one virtual machine via a second queue.

2. The apparatus of claim 1, wherein the first processing unit is a central processing unit that comprises a plurality of processor cores configured to implement the at least one virtual machine, and wherein the second processing unit is a graphics processing unit that comprises a plurality of compute units configured to implement the at least one acceleration module.

3. The apparatus of claim 2, wherein the at least one acceleration module is at least one of a classification module to classify at least one of the first packet and the second packet, an encryption module to encrypt or decrypt information included in at least one of the first packet and the second packet, a deep packet inspection (DPI) module to inspect at least one of the first packet and the second packet for at least one of a virus or an anomaly, and a compression module to compress or decompress information included in at least one of the first packet and the second packet.

4. The apparatus of claim 1, further comprising:
a memory shared by the first processing unit and the second processing unit,
wherein the memory implements the first queue and the second queue.

5. The apparatus of claim 4, wherein the first processing unit is configured to implement a plurality of virtual machines that include the at least one virtual machine, wherein the second processing unit is configured to implement a plurality of acceleration modules, and wherein the memory implements a plurality of first queues and a plurality of second queues.

6. The apparatus of claim 5, wherein each of the plurality of virtual machines is associated with a different one of the plurality of first queues and a different one of the plurality of second queues, wherein each of the plurality of first queues is configured to receive information indicating the at least one of the task and the data only from an associated one of the plurality of virtual machines and provide the information indicating the at least one of the task and the data to one of the plurality of acceleration modules, and wherein each of the plurality of second queues is configured to receive information indicating results of an operation performed by one of the plurality of acceleration modules and provide the information indicating the results to only the associated one of the plurality of virtual machines.

7. The apparatus of claim 5, wherein each of the plurality of acceleration modules is associated with a different one of the plurality of first queues and a different one of the plurality of second queues, wherein each of the plurality of first queues is configured to receive information indicating the at least one of the task and the data from the plurality of virtual machines and provide the information indicating the at least one of the task and the data only to an associated one of the plurality of acceleration modules, and wherein each of the plurality of second queues is configured to receive information indicating results of an operation performed by only one of the plurality of acceleration modules and provide the information indicating the results to the plurality of virtual machines.

8. The apparatus of claim 7, wherein the first processing unit is configured to implement a plurality of application virtual machines associated with the plurality of acceleration modules, wherein each of the plurality of application virtual machines receives the information indicating the at least one of the task and the data from the plurality of virtual machines and provides the information to one of the plurality of first queues associated with the acceleration module associated with the application virtual machine, and wherein each of the plurality of application virtual machines receive the information indicating the results of the operation performed by only one of the plurality of acceleration modules and provides the information indicating the results to the plurality of virtual machines.

9. The apparatus of claim 5, wherein the memory implements at least one third queue configured to receive packets from a network interface card and provide the packets to at least one of the plurality of first queues.

10. The apparatus of claim 5, wherein the information indicating the at least one of the task and the data comprises a pointer to a location in the memory that stores the at least one of the task and the data.

11. The apparatus of claim 5, wherein the first processing unit is configured to implement a first memory management unit to map virtual addresses used by the plurality of virtual machines to physical addresses in the memory, and wherein the second processing unit is configured to implement a second memory management unit to map virtual addresses used by the plurality of acceleration modules to physical addresses in the memory.

12. A method comprising:
providing first packets including information identifying at least one of a task and data from a plurality of virtual machines implemented in a first processing unit to a plurality of acceleration modules implemented in a second processing unit via a plurality of first queues; and
receiving, at the plurality of virtual machines via a plurality of second queues, second packets including information identifying results of operations performed on at least one of the task and the data by the plurality of acceleration modules.

13. The method of claim 12, wherein the operations performed on the at least one of the task and the data comprise classification of at least one of the first packets and the second packets by at least one of a classification module, encryption or decryption of at least one of the first packets and the second packets by an encryption module, inspection of at least one of the first packet and the second packets for at least one of a virus and an anomaly by a deep packet inspection (DPI) module, and compression or decompression of at least one of the first packets and the second packets by a compression module implemented in the second processing unit.

14. The method of claim 12, wherein providing the information identifying the at least one of the task and the data to the plurality of acceleration modules via the plurality of first queues comprises providing the information identifying the at least one of the task and the data to the plurality of acceleration modules via a plurality of first queues implemented in a memory shared by the first processing unit and the second processing unit.

15. The method of claim 14, wherein receiving the information identifying the results of the operations via the plurality of second queues comprises receiving the information identifying the results of the operation via a plurality of second queues implemented in the memory shared by the first processing unit and the second processing unit.

16. The method of claim 15, wherein providing the information identifying the at least one of the task and the data to the plurality of acceleration modules from a first virtual machine in the plurality of virtual machines comprises providing the information identifying the at least one of the task and the data only to one of the plurality of first queues that is associated with the first virtual machine, and wherein receiving information identifying the results of the operations performed by the plurality of acceleration modules at the first virtual machine comprises receiving the information identifying the results of the operations only from the one of the plurality of first queues that is associated with the first virtual machine.

17. The method of claim 15, wherein providing the information identifying the at least one of the task and the data to a first acceleration module of the plurality of acceleration modules from the plurality of virtual machines comprises providing the information identifying the at least one of the task and the data only to one of the plurality of first queues that is associated with the first acceleration module, and wherein receiving information identifying the results of the operations performed by the plurality of acceleration modules at the plurality of virtual machines comprises receiving the information identifying the results of the operations only from the one of the plurality of first queues that is associated with the first acceleration module.

18. The method of claim 17, further comprising:
receiving, at an application virtual machine associated with the first acceleration module, the information indicating at least one of the task and the data from the plurality of virtual machines;
providing, from the application virtual machine, the information to the one of the plurality of first queues associated with the first acceleration module;
receiving, at the application virtual machine, the information indicating the results of the operations performed by the first acceleration module; and
providing, from the application virtual machine, the information indicating the results to the plurality of virtual machines.

19. The method of claim 14, further comprising:
receiving, at a third queue implemented in the memory, packets from a network interface card; and
providing, from the third queue, the packets to at least one of the plurality of first queues.

20. The method of claim 14, wherein the information indicating the at least one of the task and the data comprises a pointer to a location in the memory that stores the at least one of the task and the data.
